(19) United States
(12) Patent Application Publication
(10) Pub. No.: US 2010/0312794 A1
(43) Pub. Date: Dec. 9, 2010

(54) METHOD FOR TESTING FILE TRANSMISSION FUNCTION OF MOBILE PHONE

(75) Inventor: QING-HUA LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 12/555,133

(22) Filed: Sep. 8, 2009

(30) Foreign Application Priority Data
Jun. 5, 2009 (CN) 200910302942.4

(51) Int. Cl. G06F 17/30

(52) U.S. Cl. 707/770; 707/822

(57) ABSTRACT

A method for testing file transmission function of a mobile phone, includes following steps. The mobile phone is connected to a file server and downloads a file from a first folder of the file server. The mobile phone then uploads the downloaded file to a second folder of the file server. A file comparison module checks if files in the first folder and the second folder are the same.

### BACKGROUND

1. Technical Field

The present disclosure relates to a method for testing mobile phones, and particularly to a method for testing file transmission function of a mobile phone.

2. Description of Related Art

Portable electronic devices such as mobile phones enjoy widespread popularity. In particular, characteristics of these devices provide users with access to information and communication outlets in ways that were never before available. To ensure the continued popularity of portable electronic devices, attempts are being made to further expand the flexibility and capabilities of these portable electronic devices and to further enhance the services available to users. For example, mobile phones are now capable of playing music and movies, displaying electronic books, and so on. Most of these functions require that the mobile phone have the capability of downloading electronic files, and sometime uploading files to other mobile phones. Therefore, it is important for a mobile phone to have a reliable file transmission function.

Before the mobile phones go to market, they should be tested in the factory. However, it is often troublesome and time-consuming to test the file transmission function of mobile phones in a conventional manner.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a system of an embodiment for testing file transmission function of a mobile phone;

FIG. 2 is a flow chart of a method of an embodiment for testing file transmission function of a mobile phone; and

FIG. 3 is a flow chart of a method of another embodiment for testing file transmission function of a mobile phone.

### DETAILED DESCRIPTION

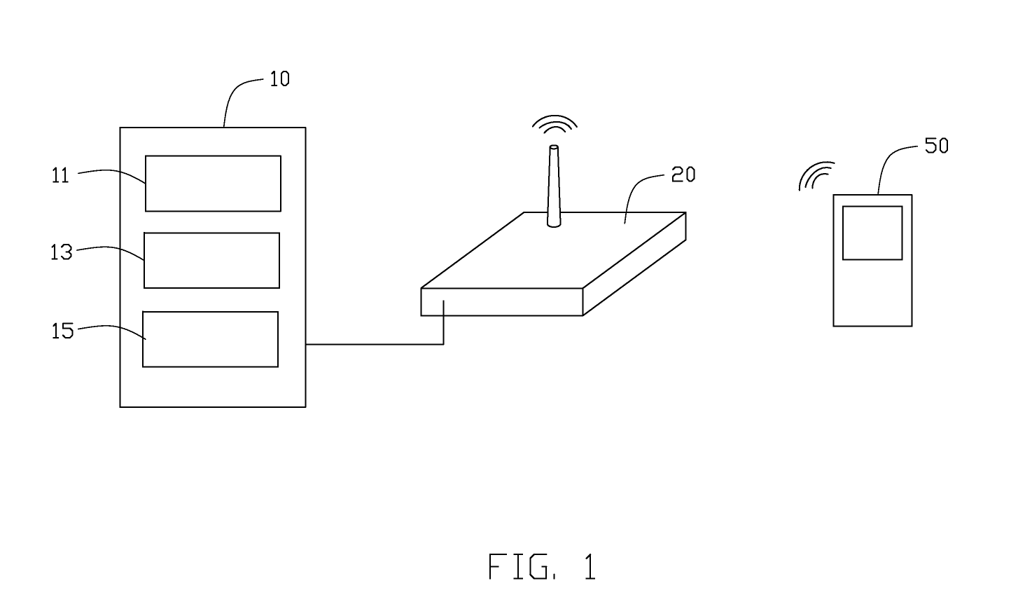

Referring to FIG. 1, a system for testing file transmission function of a mobile phone, in accordance with an embodiment, includes a file server 10 and a wireless communication apparatus 20 connected to the file server 10. The wireless communication apparatus 20 communicates with a mobile phone 50, which needs to be tested, via a wireless link, such as a wireless fidelity (WIFI) link or a Bluetooth link.

The file server 10 is configured with an IP (internet protocol) address, such as “10.1.1.1”. The mobile phone 50 connects to the file server 10 by accessing the IP address. The file server 10 includes a first folder 11, a second folder 13, and a file comparison module 15. The first folder 11 stores a plurality of files, downloadable to the mobile phone 50 when testing. The plurality of files may be named with sequential Arabic numbers, such as “1”, “2”, “3”, and so on. Therefore, a file 1, whose name is “1”, has a stored address of “10.1.1.1/first folder/1”. In the present embodiment, there are ten files separately named in sequential Arabic number of “1” to “10” stored in the first folder 11. The second folder 13 is empty, and is used to receive files uploaded from the mobile phone 50 during testing. The file comparison module 15 is capable of comparing files in the first folder 11 with files in the second folder 13 according to names of the files, sizes of the files, properties of the files, and so on.

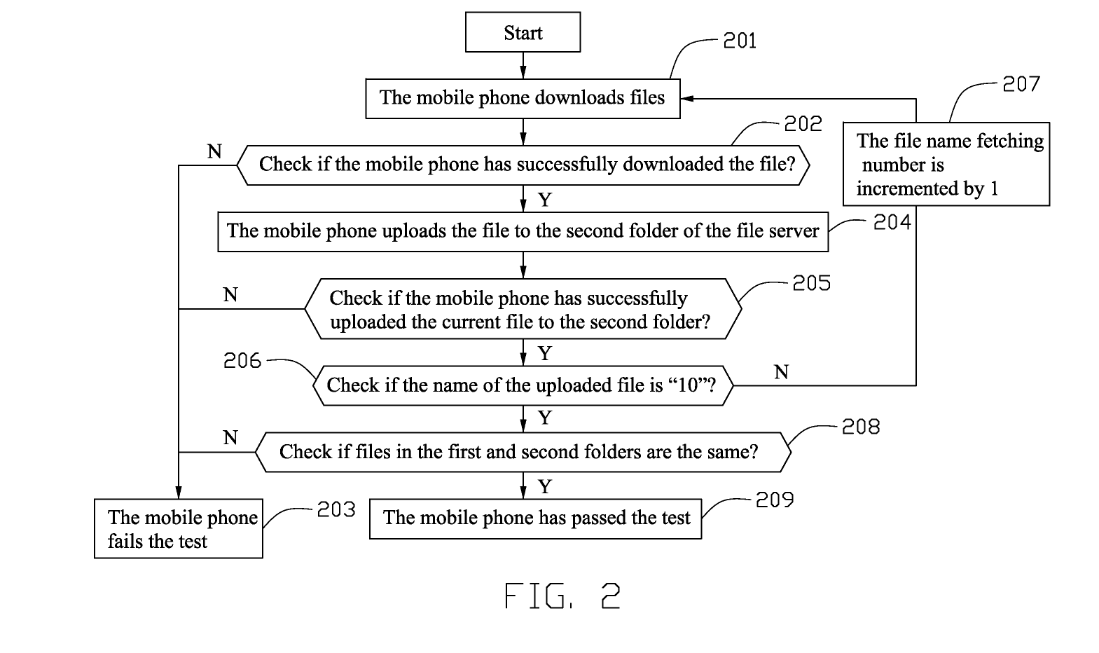

Referring to FIG. 2, a method for testing the file transmission function of the mobile phone 50, is shown as follows.

In step 201, the mobile phone 50 is connected to the file server 10 via the wireless communication module 15 using the IP address of the file server. The file name fetching number is set to 1, and then the mobile phone 50 downloads the file with the name matching the file name fetching number from the first folder 11 of the file server 10.

In step 202, check if the mobile phone 50 has successfully downloaded the current file; if it has not, go to step 203; if it has, go to step 204.

In step 203, the test is fail.

In step 204, the mobile phone 50 uploads the current file to the second folder 12 of the file server 10, then go to step 206.

In step 205, check if the mobile phone 50 has successfully uploaded the current file to the second folder 12; if it has, go to step 206; if it has not, go to step 203.

In step 206, check if the name of the uploaded file is “10”; if it is not, go to step 207; if it is, go to step 208.

In step 207, the file name fetching number is incremented by 1.

In step 208, the file comparison module 15 checks if files in the first folder 11 and the second folder 13 are the same. The file comparison module 15 compares the number of the files in the first folder 11 and the second folder 13, names of the files in the first folder 11 and the second folder 13, size and property of cognominal files in the first folder 11 and the second folder 13. If the files in the first folder 11 and the second folder 13 are the same, go to step 209; if not, go to step 203.

In step 209, the mobile phone 50 has passed the test.

The above method is an example of one embodiment. In the example, the number of files to be downloaded or uploaded is not limited to 10, and can be changed to other number. The naming system is not limited to the above system in the example, and can be other similar system that can achieve the above test.

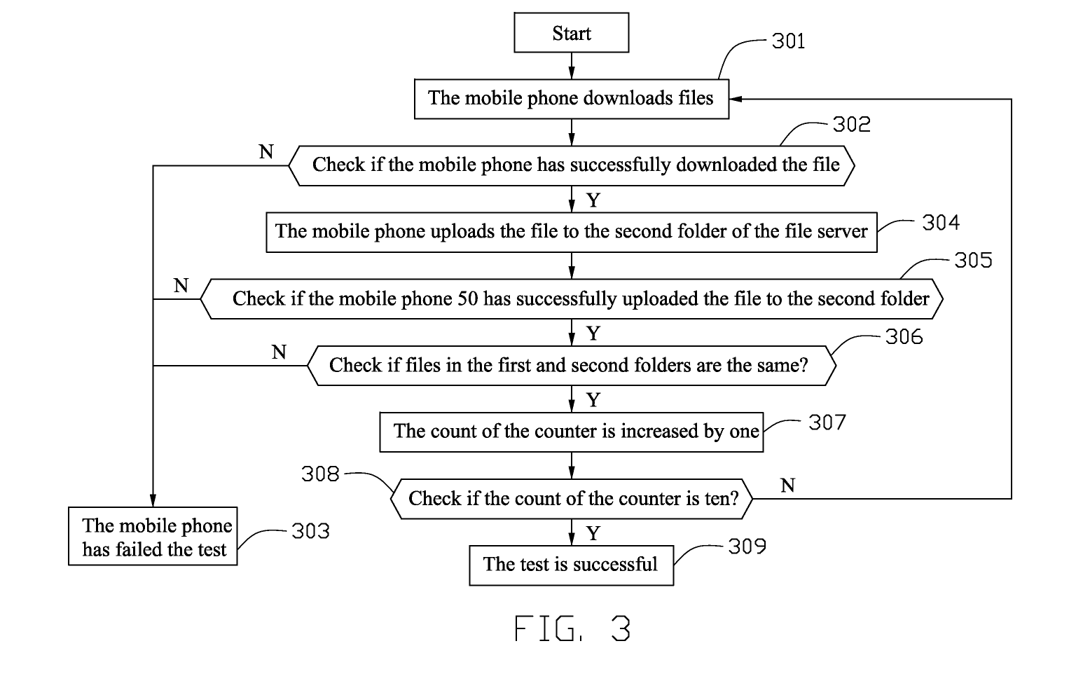

Referring to FIG. 3, another embodiment for testing the file transmission function of the mobile phone 50, is shown. In this method, there is only one file stored in the first folder 11. The method is as follows.

In step 301, the mobile phone 50 is connected to the file server 10 via the wireless communication module 15 using the IP address of the file server; then the mobile phone 50 downloads the file from the first folder 11 of the file server 10.

In step 302, check if the mobile phone 50 has successfully downloaded the file; if it has not, go to step 303; if it has, go to step 304.

In step 303, the mobile phone 50 has failed the test.

In step 304, the mobile phone 50 uploads the file to the second folder 12 of the file server 10, then go to step 305.

In step 305, check if the mobile phone 50 has successfully uploaded the file to the second folder 12; if it has, go to step 306; if it has not, go to step 303.

In step 306, the file comparison module 15 checks if the files in the first folder 11 and the second folder 13 are the same; the file comparison module 15 compares names of the files in the first folder 11 and the second folder 13, size and property of cognominal files in the first folder 11 and the second folder 13. If the files in the first folder 11 and the second folder 13 are the same, go to step 307; if not, go to step 303.

In step 307, a count of a counter, whose initial count is zero, is increased by one; then go to step 308.

In step 308, check if the count of the counter is ten; if it is, go to step 309; if it is not, go back to step 301.

In step 309, the test is successful, and the count of the counter is set to zero.

The above method is an example of one embodiment. In the example, the number of files to be downloaded or uploaded is not limited to 10, and can be changed to other number. The naming system is not limited to the above system in the example, and can be other similar system that can achieve the above test.

In the two above methods, after the test is successful, a file download speed and a file upload speed of the mobile pone 50 is counted based on the size of the files, length of time of downloading and uploading files.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for testing file transmission function of a mobile phone, comprising following steps:
connecting the mobile phone to a file server;
downloading a file from a first folder of the file server;
uploading the downloaded file to a second folder of the file server; and
comparing the files in the first folder and the second folder to determine if they are the same.

2. The method of claim 1, wherein there is a plurality of files stored in the first folder, each of the plurality of files is downloaded to the mobile phone, and then uploaded to the second folder; a file comparison module compares numbers of the files in the first folder and the second folder, names of the files in the first folder and the second folder, size and property of cognominal files in the first folder and the second folder to check if files in the first folder and the second folder are the same.

3. The method of claim 2, wherein the plurality of files are named with sequential Arabic numbers.

4. The method of claim 1, wherein there is one file stored in the first folder, the file is downloaded in the mobile phone and uploaded to the second folder a preset number of times.

5. The method of claim 4, wherein a file comparison module compares names, size, and property of the files in the first folder and the second folder to check if files in the first folder and the second folder are the same.

6. The method of claim 1, wherein the file server is configured with an IP address and the mobile phone connects to the file server by accessing the IP address.

7. The method of claim 1, wherein a file download speed and a file upload speed of the mobile pone is counted based on the size of the file, length of time of downloading and uploading file.

8. A method for testing file transmission function of a mobile phone, comprising following steps:
connecting the mobile phone to a file server which comprising a first folder and a second folder;
storing at least one file in the first folder;
downloading the at least one file from the first folder of the file server to the mobile phone;
uploading the at least one file to the second folder of the file server;
comparing the files in the first folder and the second folder to determine if they are the same.

9. The method of claim 8, wherein the at least one file comprises a plurality of files, each of the plurality of files is downloaded to the mobile phone, and then uploaded to the second folder; a file comparison module compares numbers of the files in the first folder and the second folder, names of the files in the first folder and the second folder, size and property of cognominal files in the first folder and the second folder to check if files in the first folder and the second folder are the same.

10. The method of claim 9, wherein the plurality of files are named with sequential Arabic numbers.

11. The method of claim 8, wherein the at least one file comprises a file, the file is downloaded in the mobile phone and uploaded to the second folder a preset number of times.

12. The method of claim 11, wherein the file comparison module compares names, size, and property of the files in the first folder and the second folder to check if files in the first folder and the second folder are the same.

13. The method of claim 8, wherein the file server is configured with an IP address and the mobile phone connects to the file server by accessing the IP address.

14. The method of claim 8, wherein a file download speed and a file upload speed of the mobile pone is counted based on the size of the file, length of time of downloading and uploading file.
